(19) United States
(12) Patent Application Publication
(10) Pub. No.: US 2018/0166058 A1
(43) Pub. Date: Jun. 14, 2018

(54) ACOUSTIC ATTENUATION PANEL MADE OF AN OXIDE CERAMIC COMPOSITE MATERIAL WITH A CORE MADE OF AN ELECTROCHEMICALLY-CONVERTED METAL MATERIAL

(71) Applicant: Safran Nacelles, GONFREVILLE L'ORCHER (FR)

(72) Inventors: Arnaud DELEHOUZE, Gonfreville L'Orcher (FR); Sylvain SENTIS, Gonfreville L'Orcher (FR); Bertrand DESJOYEAUX, Gonfreville L'Orcher (FR)

(73) Assignee: Safran Nacelles, GONFREVILLE L'ORCHER (FR)

(21) Appl. No.: 15/878,431

(22) Filed: Jan. 24, 2018

Related U.S. Application Data
(63) Continuation of application No. PCT/FR2016/051936, filed on Jul. 25, 2016.

(30) Foreign Application Priority Data
Jul. 24, 2015 (FR) 15/57083

(51) Int. Cl. G10K 11/168; B32B 3/12; B32B 18/00; C25D 11/24; C04B 38/06; C04B 35/71

(52) U.S. Cl. CPC G10K 11/168; B32B 3/12; B32B 18/00; C25D 11/246; B32B 2605/18; C04B 35/71; B32B 2250/40; B32B 2262/105; B32B 2307/102; C04B 38/06

(57) ABSTRACT

The present disclosure relates to a method for producing an acoustic attenuation panel having two outer skins made from a composite material with a ceramic matrix containing a fibrous reinforcement. The skins are assembled on each side of a central honeycomb core having walls forming acoustic cavities produced by at least partial electrochemical conversion of aluminum into aluminum oxide. The method includes inserting a fugitive filler material into the acoustic cavities, leaving an annular space free in each cavity, on each side against the skin, extending around the cavity, and a step of sintering the composite material, in which the fugitive material is removed and the spaces around the cavities are filled with the composite material.

### CROSS-REFERENCE TO RELATED APPLICATIONS

This application is a continuation of International Application No. PCT/FR2016/051936, filed on Jul. 25, 2016, which claims priority to and the benefit of FR 15/57083 filed on Jul. 24, 2015. The disclosures of the above applications are incorporated herein by reference.

### FIELD

The present disclosure relates to the field of acoustic attenuation panels, in particular intended to equip the hot areas of ejecting gases of an aircraft turbojet engine. More specifically, the present disclosure concerns a method for manufacturing an acoustic attenuation panel made of a ceramic-matrix composite material, as well as an acoustic attenuation panel obtained by such a method, and an aircraft turbojet engine including an acoustic attenuation panel according to the present disclosure.

### BACKGROUND

The statements in this section merely provide background information related to the present disclosure and may not constitute prior art.

The turbojet engines include aerodynamic surfaces for guiding the flow of ejected hot gases, which may be subjected to high temperatures that may exceed 600° C., and in some cases, reach 1000° C.

In order to reduce the noises emitted by the turbojet engine in operation, it is known to make aerodynamic guide surfaces with metal acoustic panels or acoustic panels made of a non-oxide ceramic-matrix composite material including a sandwich-type structure composed of a core material encapsulated between two skins.

The central core includes transverse walls forming a large number of closed cells, which may have in particular a honeycomb shape.

The front skin turned toward the sound source, has gas passages formed by micro-perforations, opening into resonant cavities formed by the closed cells of the central core, so as to constitute Helmholtz resonators achieving an attenuation of the acoustic emissions emitted by the turbojet engine.

The acoustic panels of the prior art raise different issues. The mass is relatively significant. In addition, it has temperature limitations which may be reached, in particular in the turbojet engines. It also has limitations of the exposure time in some environments.

Alternatively, it is known to make the sandwich structure in a ceramic-matrix composite material “CMC”, with a ceramic which is not an oxide. This material is both resistant and light. Nonetheless, it has limitations of the exposure time in some environments. In addition, the manufacture of a central core and of the skins in this material is very complex and expensive.

### SUMMARY

The present disclosure provides a method for manufacturing an acoustic attenuation panel comprising two external skins made of a ceramic-matrix composite material containing a fibrous reinforcement, assembled on either side of a cellular central core including walls forming acoustic cavities made by an at least partial electrochemical conversion of aluminum into aluminum oxide, this method being remarkable in that it includes a step of inserting into acoustic cavities a fugitive filling material leaving free in each cavity, on either side against the skin, an annular space encircling this cavity, and a step of sintering the ceramic composite material achieving an elimination of the fugitive material, with a filling of the spaces around the cavities with the composite material.

An advantage of this manufacturing method is that, by adapting the matter as well as the shapes of the fugitive material, a protection preserving the inner volume of the cells is obtained during the sintering, avoiding a deformation of the skins toward this volume as well as a flow of the matrix inside, which would reduce the volume of the cells thereby reducing the acoustic performance of the panels.

At the same time, by filling with the composite material spaces along the circumference of the cavities, larger adhesion surfaces are provided between the skins and the central core thereby considerably increasing the mechanical strength of the panel.

The manufacturing method according to the present disclosure may include one or more of the following characteristics, which may be combined together.

Advantageously, the manufacturing method comprises an additional step intended to make, during the molding, perforations of one of the skins made of a composite material. A large number of perforations is rapidly obtained.

This additional step may include making tips on the fugitive filling material, in this same material, passing through a fibrous reinforcement of a skin.

Alternatively, the additional step may include depositing on the external side of a fibrous reinforcement provided for one skin, a plate equipped with tips passing through this reinforcement. These tips are made of a fugitive material, or of a material capable of withstanding the sintering step, in which case the inserts have a demoldable shape.

The manufacturing method may use, to make the skins, dry fibrous reinforcements receiving afterwards the matrix by filtration, or fibrous reinforcements pre-impregnated with a matrix.

Advantageously, the fugitive material may be any material that can disappear during the sintering operation, the fugitive material may include one or several material(s) selected among the thermoplastic and thermosetting plastic materials.

Advantageously, making the acoustic cavities includes a step of assembling together aluminum lamellae by means of work-hardening, crimping, welding, or bonding with a preceramic adhesive.

The present disclosure also relates to an acoustic attenuation panel made of a ceramic composite material, made by a method comprising any one of the preceding characteristics.

In other words, the acoustic attenuation panel of the present disclosure is an acoustic attenuation panel comprising a cellular central core composed of aluminum oxide, enclosed between the two external skins made of a ceramic-matrix composite material.

Providing a cellular core composed of aluminum oxide enables the acoustic attenuation panel of the present disclosure to withstand temperatures much higher than the melting temperature of the aluminum comprised between 500° C. and 600° C., the melting temperature of the aluminum oxide being higher than 2000° C. Using the aluminum oxide to form the cellular core of the acoustic attenuation panel made of a ceramic-matrix composite material advantageously enables a use of said panel in hot areas of the engine which may be subjected to temperatures that may be comprised between 600° C. and 2000° C.

Advantageously, the aluminum of the walls of the acoustic cavities is completely converted into aluminum oxide.

Advantageously, the connection of the ceramic composite material of the skins with the walls of the central core substantially forms a blend radius. The shape of a radius provides, with little matter, a high strength.

Advantageously, the two skins comprise a metal oxide fibrous reinforcement and a metal oxide matrix.

In particular, the matrix and the fibrous reinforcement of the skins may comprise at least two different ceramic materials. Thus, the local characteristics of the matrix are adapted according to the constraints.

According to one form, the central core includes drain passages between cavities.

The central core may include, on its sides, gripping slots on the skins.

In addition, the present disclosure also relates to an aircraft propulsion unit (that is to say the set formed by a turbojet engine equipped with its nacelle, this set may include the engine mast), the propulsion unit including one or several acoustic attenuation panel(s) comprising any one of the characteristics defined hereinabove.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is an overall view of an acoustic panel made of a composite material according to the present disclosure;

FIG. 2 is a top view of walls of acoustic cavities of an acoustic panel comprising a honeycomb-shaped structure according to the present disclosure;

FIG. 2a is a detailed view of one method for manufacturing a honeycomb-shaped structure according to the present disclosure;

FIG. 2b is a detailed view of another method for manufacturing a honeycomb-shaped structure according to the present disclosure;

FIG. 3 is a perspective view of an acoustic cavity wall according to one variant of the present disclosure;

FIG. 4 is a perspective view of an acoustic cavity wall according to another variant of the present disclosure;

FIG. 5 is a perspective view of an acoustic cavity wall according to one variant of the present disclosure;

FIG. 6 is a front view presenting a method for making a panel according to the present disclosure;

FIG. 7 is a detail view of a link between a skin and a partition wall according to the present disclosure;

FIG. 8 presents a mechanical assembly of a panel according to the present disclosure;

FIG. 9 presents a method for perforating upper skin according to the present disclosure; and

FIG. 10 presents another method for perforating upper skin according to the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

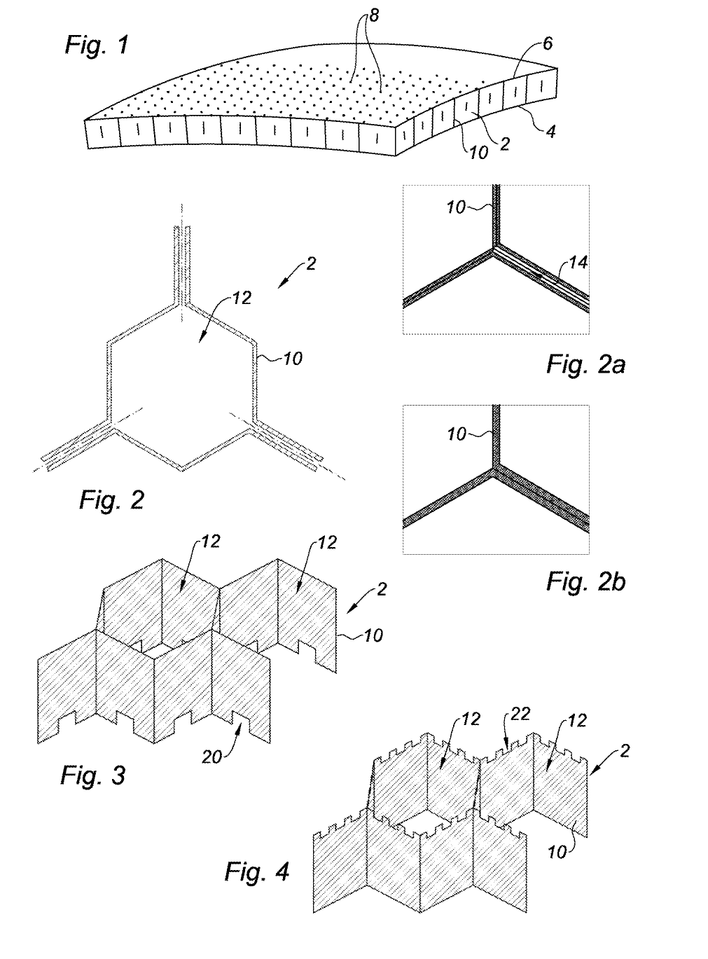

FIG. 1 presents an acoustic panel including a central core 2 with a constant or variable thickness, including walls disposed transversely 10 delimiting a large number of juxtaposed acoustic cavities.

The acoustic panel receives on one side, conventionally called rear side, a tight rear skin 4, and on a front side intended to be turned toward the sound source, a front skin 6 having a large number of small perforations 8 opening in principle into all the acoustic cavities.

The skins 4, 6 are made of a ceramic-matrix composite material “CMC”, including ceramic material fibers integrated into a matrix also made of a ceramic material. The fibers may be long or short fibers. In particular, for the fibers and the matrix, it is possible to use metal oxides.

FIG. 2 presents the walls 10 disposed transversely in the panel, constituting hexagonal resonant cavities 12 disposed according to a honeycomb shape. Alternatively, the cavities may have other shapes.

The walls 10 of the cavities 12 are formed by a metal converted, through an electrochemical process, into ceramic, having a high melting point. For this purpose, aluminum which is converted into aluminum oxide or alumina is used in order to obtain a structure having a resistance compatible with the method for making the sandwich panel, in particular the temperature for the sintering of the ceramic-matrix skins. It should be noted that the melting temperature of the aluminum oxide is higher than 2000° C.

In addition, the structure should resist the different physicochemical constraints in the targeted applications, in particular in the case of aerodynamic surfaces for guiding the hot gases flow of the turbojet engines.

The method for manufacturing the structure of the central core 2 is as follows.

Aluminum lamellae are assembled together by different processes such as work-hardening, crimping, friction welding, or bonding with a preceramic adhesive. The forming of the core material to the shape of the part is carried out either prior to this assembly or subsequently.

Afterwards, the electrochemical treatment of the structure is carried out, which results in a conversion into aluminum oxide with a volume inflation.

As presented in FIG. 2a, after a partial conversion of the aluminum lamellae into alumina, a residual aluminum layer 14, which has not been converted into aluminum oxide, is obtained.

As presented in FIG. 2b, after a complete conversion of the aluminum lamellae into alumina, a continuity of the alumina layer at the location of the assembly junctions of the aluminum lamellae guaranteeing the mechanical strength of the core material, is obtained.

The shape and the dimensions of the resonant cavities 12 may be varied, in particular in width and in height. It is possible to have a contour other than hexagonal shape. It is also possible to vary the characteristics of the resonant cavities on the same panel, according to the locations. These different characteristics are adapted to address, particularly at each location, the acoustic attenuation needs and the desired mechanical strength.

FIG. 3 presents a variant of the walls 10 of the cavities 12 including, at the base of each face of the walls, a cut-out, rectangular in this example, forming a drain passage 20 between two cavities.

The drain passage 20 includes a height sufficient to preserve a passage between the cavities 12 once the skin is assembled on these walls 10, so as to be able to drain a liquid entering into these cavities when the panel is used. Alternatively, the drain holes may have other shapes.

Alternatively, when the ceramic matrix is infiltrated, these holes are filled beforehand by the insertion of a fugitive filling material. These volumes of fugitive filling material may be integrated to those used to fill the volumes left free by the cavities of the core material.

FIG. 4 presents a variant of the walls 10 of the cavities 12, including at the top of each face of the walls, a series of small cut-outs, rectangular in this example, forming slots 22, intended to provide a penetration into the skin disposed in front, so as to obtain a better mechanical anchorage of this skin on the central core 2.

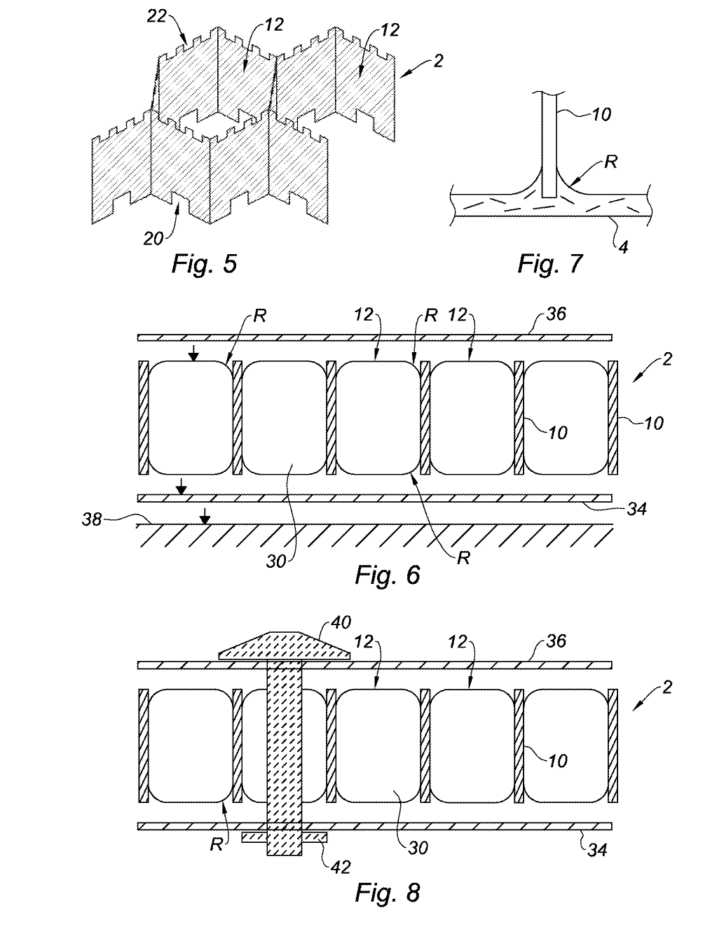

FIG. 5 presents a central core 2 combining the two preceding variants, including the drain passages 20 below and the slots 22 above.

Complementarily, it is possible to carry out any combination of these variants, including for example slots 22 on both sides of the central core 2.

FIG. 6 presents a method for manufacturing the acoustic panels, by filtration of the matrix in the fibers.

A first reinforcement of dry ceramic fibers 34 is deposited in a mold 38.

Afterwards, the central core 2 is deposited, which has received beforehand in each cavity 12 a fugitive filling material 30 filling the entire volume from one side to the other and where appropriate the drain holes. Alternatively, it is possible to fill the cavities 12 after depositing the central core 2.

The filling material 30 of each cavity 12 includes on each side a blend radius R encircling the cavity, connecting the horizontal faces with the vertical faces of this material. The blend radius R forms the equivalent of a convex meniscus on each side of the filling material 30.

In this manner, there remains for each side of the cavity 12 a small space encircling it, between the walls 10 and the horizontal plane receiving a skin 4, 6.

Finally, the second reinforcement of dry ceramic fibers 36 is deposited, and then an upper pressing means is placed so as to tighten the stacking on the central core 2.

Afterwards, a filtration of the ceramic matrix is carried out in the two reinforcements of fibers 34, 36, by the powder ceramic material forming a barbotine carried by a fluid acting as a vector in the supply of the powders, than a drying in order to eliminate this fluid, or a polymerization in the case where the final ceramic matrix is brought by a preceramic resin. In particular, a fluid compatible with the fugitive filling material 30 is selected, in order to inhibit the mixing or the dissolution thereof.

In particular, the matrix and the fibrous reinforcement of the skins may comprise at least two different ceramic materials in order to adapt the local characteristics of this matrix according to the constraints.

Finally, a temperature sintering of the matrix is carried out in order to perform an aggregation of the matrix and fibers sets, and achieve the assembly with the central core 2.

The fugitive filling material 30 is selected so as to obtain its elimination, at least partially or completely, during the temperature sintering operation, in particular by combustion, fusion, oxidation, sublimation, and evaporation. In particular, the fugitive material may include any material that can disappear during the sintering operation. It is possible to use in particular one or several material(s) selected among the thermoplastic plastic materials (such as polyethylene), the thermosetting plastic (for example epoxy-based) materials, or the low-melting-point metals (for example, aluminum, lead or tin-based metals).

The skins are selected so as to enable, during this operation, a passage towards the outside of the filling material 30, so as to let it escape.

The fugitive filling material 30 avoids a collapse of the external skins into the cavities 12 in the case of pre-impregnated fibrous reinforcements. In the case of a filtration, it also avoids the filling of the cavities 12 by the matrix.

It should be noted that, thanks to the upper pressing of the stacking on the central core 2, a filling by the matrix of all the available volumes is obtained, in particular of the spaces left free by the blend radii R along the circumference of each cavity 12.

FIG. 7 presents the matrix of the skin 4 then covering, for each side of the panel, over a small height, the ends of each face of the walls 10 with a radius R identical to that of the fugitive filling material 30, which forms a large contact surface between this matrix and the central core 2. A very strong adherence is obtained between the skins 4, 6, and this central core 2.

Alternatively, it is possible to use a method for manufacturing the acoustic panels using pre-impregnated fibrous reinforcements to make the skins 4, 6.

Then, the first pre-impregnated reinforcement 34, then the central core 2 containing the filling material 30, or receiving this material subsequently, and finally the second pre-impregnated reinforcement 36 are deposited in the mold 38. The sintering operation remains similar, with an equivalent function for the filling material, avoiding a local sinking of the skins into the cavities 12, and providing a considerable contact surface with the walls 10 thanks to the spaces left free by the blend radii R.

Complementarily, it is possible to deposit a thin layer of a preceramic adhesive between the fibrous reinforcements 34, 36 and the central core 2 in order to improve the link.

Alternatively, it is possible to use a method for manufacturing the acoustic panels using consolidated or already sintered skins, which are bonded on the central core 2 by coating with an intermediate preceramic glue which is polymerized afterwards.

For this method, the temporary filling material 30 fills in the same role, avoiding a filling of the cavities 12 with the glue, and forming a considerable contact surface with the walls 10 thanks to the spaces left free by the blend radii R of this material.

Complementarily, FIG. 8 presents a mechanical assembly, by a screw 40 having a large head, which tightens the staking of the components of the panel thanks to a nut 42 disposed beneath, bearing on a wide surface.

In particular, it is possible to reinforce the central core 2 at the level of the tightening screw 40, by filling, in order to avoid a crushing of the panel at this location. Alternatively, it is possible to use any other tightening means.

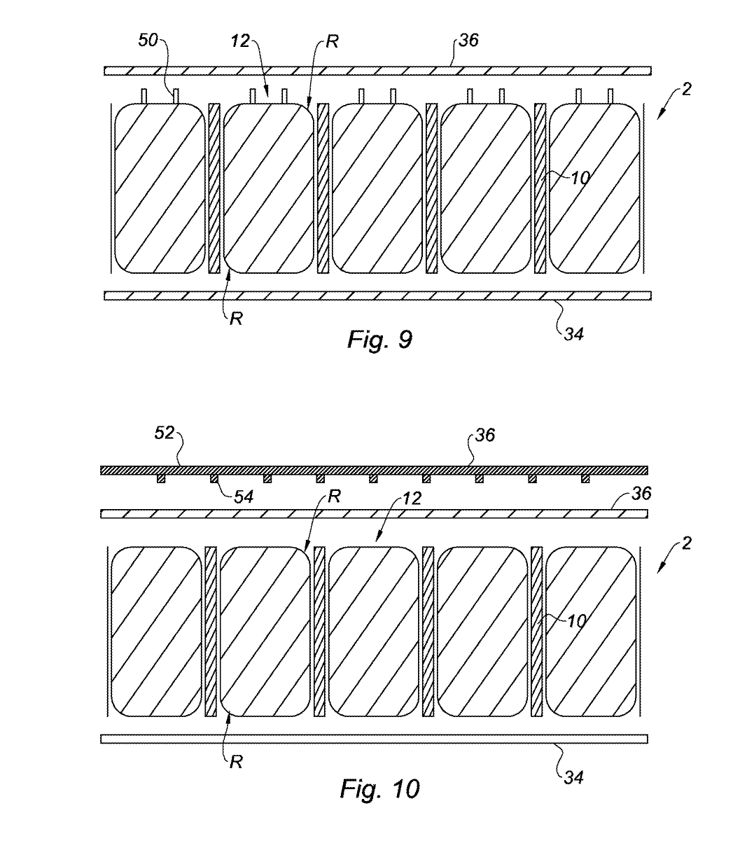

FIG. 9 presents a first method for making the perforations on the upper skin 36 during the manufacture of the panel.

Tips turned upwards 50, formed by a material which is eliminated during the sintering of the ceramic material, are disposed on the top of the filling material 30 in each cavity 12. When depositing the upper fibrous reinforcement 36, which may be pre-impregnated with the ceramic matrix, or receiving this matrix afterwards by filtration, the tips 50 pierce this reinforcement and pass completely therethrough.

After the sintering operation, the tips 50 disappear leaving equivalent perforations in the upper skin.

FIG. 10 presents a second method for making the perforations on the upper skin 36.

After having completed the stacking of the two fibrous reinforcements 34, 36 and of the central core 2, a plate 52 including a series of tips 54 turned downwards, passing completely through this reinforcement, is disposed on the upper reinforcement.

After the sintering operation of the ceramic matrix of the skins, the plate 52 is removed, its tips 54 leaving equivalent perforations in the upper skin. It is also possible to dispose on the plate 52 tips 54 made of a material which disappears during the sintering operation.

For these methods for making the perforations, the height of the tips 50, 54 may be adjusted to the thickness of the fibrous reinforcement 36 to cross.

Alternatively, the length of the tips 50, 54 may be greater with a projection on the other side of the fibrous reinforcement 36, in order to guarantee a complete perforation of the upper skin. In this case, for the first method, it is possible to perform a leveling of the ends of the projecting tips 50 before the closure of the mold, or introduce these ends in recesses provided in the cover of the mold. For the second manufacturing method, the end of the tips 54 may sink into the fugitive filling material 30.

It should be noted that these methods for carrying out the perforations deviate the fibers during the introduction of the tips 50, 54 without cutting them, which does not deteriorate the mechanical strength of the thus perforated skin.

Alternatively, it is possible to make the perforations by any other method, such as mechanical drilling, or laser drilling.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A method for manufacturing an acoustic attenuation panel comprising two external skins made of a ceramic-matrix composite material containing a fibrous reinforcement, assembled on either side of a cellular central core including walls forming acoustic cavities made by an at least partial electrochemical conversion of aluminum into aluminum oxide, the method comprising:
inserting fugitive filling material into each acoustic cavity such that an annular space encircles at least one side of each acoustic cavity against at least one of the two external skins; and
sintering the ceramic-matrix composite material such that the fugitive filling material is partially or completely eliminated and the ceramic-matrix composite material fills the annular spaces around each cavity.

2. The manufacturing method according to claim 1 further comprising the step of forming perforations on at least one of the two external skins made of a composite material during the sintering step.

3. The manufacturing method according to claim 2, wherein forming the perforations includes forming tips on the fugitive filling material passing through a fibrous reinforcement of the at least one external skin.

4. The manufacturing method according to claim 3, wherein the tips and the fugitive filling material are the same material.

5. The manufacturing method according to claim 2, wherein forming the perforations includes depositing, on an external side of a fibrous reinforcement of the at least one external skin, a plate equipped with tips passing through the fibrous reinforcement.

6. The manufacturing method according to claim 1, wherein dry fibrous reinforcements receiving the ceramic-matrix composite material by filtration or fibrous reinforcements pre-impregnated with the ceramic-matrix are used to make at least one of the two skins.

7. The manufacturing method according to claim 1, wherein the fugitive filling material, is a thermoplastic or a thermosetting material.

8. The manufacturing method according to claim 1, wherein forming the acoustic cavities includes assembling aluminum lamellae by work-hardening, crimping, welding, or bonding with a preceramic adhesive

9. An acoustic attenuation panel made of a ceramic-matrix composite material, the acoustic attenuation panel manufactured by the method according to claim 1.

10. The acoustic attenuation panel according to claim 9, wherein aluminum in the walls of the acoustic cavities is completely converted into aluminum oxide.

11. The acoustic attenuation panel according to claim 9, wherein a connection of the ceramic-matrix composite material of the skins with the walls of the central core substantially forms a blend radius.

12. The acoustic attenuation panel according to claims 9, comprising two external skins, each comprising comprising a metal oxide fibrous reinforcement and a metal oxide matrix.

13. The acoustic attenuation panel according to claim 12, wherein the metal oxide matrix and the metal oxide fibrous reinforcement of the two external skins comprises at least two different ceramic materials.

14. The acoustic attenuation panel according to claim 9, wherein the central core includes drain passages between the acoustic cavities.

15. The acoustic attenuation panel according to claim 9, wherein the sides of the central core includes gripping slots on the external skins.

16. An aircraft propulsion unit including at least one acoustic attenuation panel according to claim 9.
